(19) United States
(12) Patent Application Publication
(10) Pub. No.: US 2014/0379519 A1
(43) Pub. Date: Dec. 25, 2014

(54) E-COMMERCE CROSS-SAMPLING PRODUCT RECOMMENDER BASED ON STATISTICS

(71) Applicant: Texas Instruments Incorporated, Dallas, TX (US)

(72) Inventors: JOEL LYNN DOBSON, ROWLETT, TX (US); CHRISTOPHER COOK, PLANO, TX (US)

(21) Appl. No.: 13/926,540

(22) Filed: Jun. 25, 2013

(51) Int. Cl. G06Q 30/06

(52) U.S. Cl. CPC G06Q 30/0631
USPC 705/26.7

(57) ABSTRACT

A method of recommending products during e-commerce. A computing device including a processor implements a cross sampling recommender algorithm which includes a first statistical model is provided at a website. Responsive to receiving information via the Internet from a first customer including selection of a first product offered at the website, the algorithm automatically divides historical customer' selection information into a plurality of time ordered sub-periods of time. Using the customer' selection information and the time ordered sub-periods of time as a time covariate, logistic regressions are fit to each of a plurality of cross-sampled pairs of the plurality of products involving the first product. Using the data from the logistic regressions, cross-sampled pairs are identified which meet a slope selection criteria. A recommendation to the first customer for at least a first recommended product from the cross-sampled pairs is provided from cross-sampled pairs which meet the slope selection criteria.

### FIELD

Disclosed embodiments relate to electronic commerce-based recommending of products.

### BACKGROUND

Electronic commerce is one method of selling products (goods) and services to consumers. The popularity of electronic commerce has resulted in an increasing number of vendors making their products and services available for sale over electronic networks, such as over the Internet.

One feature of electronic commerce used by vendors is a recommendations feature, where when a customer selects an item for purchase, or places an item on a list, the hosting electronic commerce site automatically provides one or more recommendations of alternative and/or complimentary items for the customer to consider to purchase. These recommendations may be based on criteria including the customer's prior purchases and purchase tendencies, recommendations from the product vendor, what other customers have purchased, top sellers or recent releases, and product categories.

### SUMMARY

Disclosed embodiments provide methods and systems that utilize automatic cross sampling recommender algorithms which include at least one statistical model comprising at least a first statistical model which utilizes historic sample customer data (e.g., from many prior quarters from all customers). The first model is a trended model that automatically recommends cross-samples based on rising star cross products reflected in higher recent selection rates. The second model uses statistical cross-matching frequencies (or rates) for identifying long term winning cross products. In one embodiment first model and the second models are both used, and in another embodiment using the first model and the second model, the product recommendations generated reflect both the first model and the second models.

### BRIEF DESCRIPTION OF THE DRAWINGS

Reference will now be made to the accompanying drawings, which are not necessarily drawn to scale, wherein:

FIG. 1 is a flow chart that shows steps in an example method for recommending products based on statistics during e-commerce, according to an example embodiment.

FIG. 2 is an example system for recommending products based on statistics during e-commerce, according to an example embodiment.

FIG. 3 is a portion of a data table that includes data associated with implementation of the second statistical model which is operable to identify long term winning cross matches, according to an example embodiment.

FIG. 4 is a portion of a data table that includes data associated with implementation of the first statistical model which is operable to identify rising stars cross matches, according to an example embodiment.

FIG. 5 is a plot of type as a function of time over a 1,000 day period for a particular cross match (10 quarters), so that 10 periods of time having data are shown each representing a particular quarter, according to an example embodiment.

FIG. 6 shows actual click-through rate data obtained after implementing a disclosed automatic cross sampling recommender algorithm (CSRA) that included both of the first and second statistical models.

### DETAILED DESCRIPTION

Example embodiments are described with reference to the drawings, wherein like reference numerals are used to designate similar or equivalent elements. Illustrated ordering of acts or events should not be considered as limiting, as some acts or events may occur in different order and/or concurrently with other acts or events. Furthermore, some illustrated acts or events may not be required to implement a methodology in accordance with this disclosure.

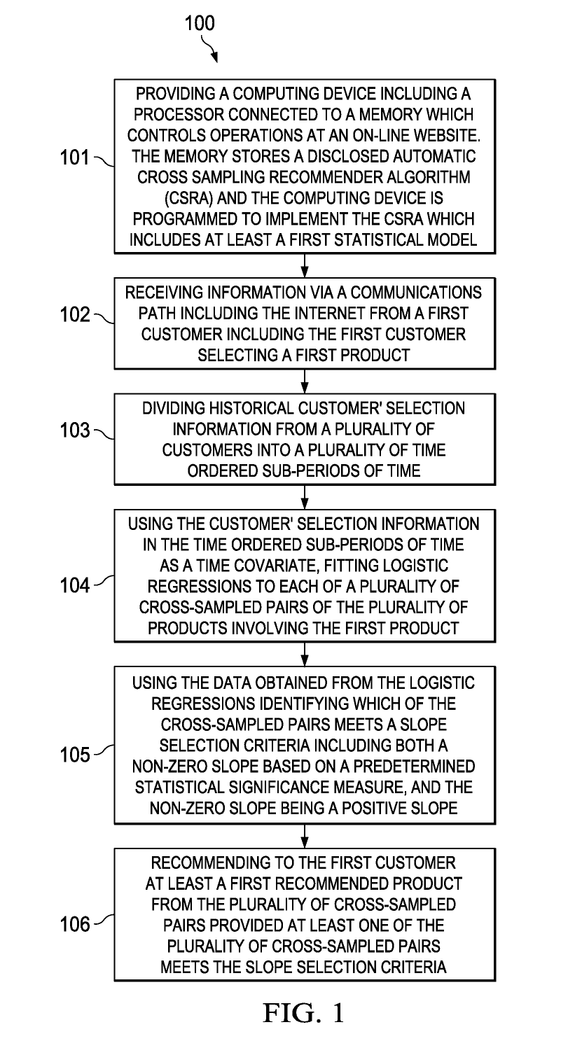

FIG. 1 is a flow chart that shows steps in an example on-line method 100 for recommending products based on statistics during e-commerce, according to an example embodiment. Step 101 comprises providing a computing device including a processor connected to a memory which controls operations at an on-line website. The memory stores a disclosed automatic CSRA and the computing device is programmed to implement the CSRA which includes at least a first statistical model.

Step 102 comprises receiving information via a communications path including the Internet from a first customer including the first customer selecting (for sale or sampling) a first product from a plurality of products offered at the on-line website. In response to receiving the information from the first customer, the CSRA automatically implements steps 103-106. Step 103 comprises dividing historical customer' selection information (from a plurality of customers) for the plurality of products spanning a first period of time (e.g. several years) into a plurality of time ordered sub-periods of time (e.g., quarters, 3 months).

Step 104 comprises using the customer' selection information in the time ordered sub-periods of time as a time covariate, fitting logistic regressions to all of the cross-sampled pairs of the plurality of products involving the first product. Each pair thus includes the product the individual has just selected paired up with every other device that has ever been ordered by anyone with that particular device the individual just selected within the product database at hand, such as a datasheet for electronic products.

For example, using the time ordered quarterly historic samples data, logistic regressions can be fit for each pair of cross-sampled products. Logistic regression measures the relationship between a categorical dependent variable and one or more independent variables, which are usually continuous, by using probability scores/values (p-value) as the predicted values of the dependent variable.

Step 105 comprises using the data obtained from the logistic regressions for identifying which of the cross-sampled pairs meets a slope selection criteria including both a non-zero slope based on a predetermined statistical significance measure, and the non-zero slope being a positive slope (which indicates occurrence increasing with time). The predetermined statistical significance measure can be a p-value being below a predetermined level, wherein a null hypothesis corresponds to a zero slope, and wherein the null hypothesis rejected determines a non-zero slope is present only when the p-value is below the predetermined level. Among all the pairs of cross-sampled products including the product selected by the customer, ones of the pairs of cross-sampled products for which the slope is positive and statistically significant (e.g., having p-value below 0.05) may be identified.

Step 106 comprises recommending to the first customer at least a first recommended product from the cross-sampled pairs provided at least one of the cross-sampled pairs meet the slope selection criteria. The product recommendations can be ordered on an Internet web page according to ascending p-value among all logistic regressions involving the product selected by the first customer. The smallest p-values correspond to those product pairs which are the fastest risers, or the rising stars. If none of the cross-sampled pairs meet the slope selection criteria, the method can include raising the p-value to a new p-value above the predetermined level and then repeating the fitting logistic regressions, identifying, and recommending.

The CSRA can further include a second statistical model, which calculates rates of the cross-sampled pairs involving the first product over the first period of time, and recommends at least a second recommended product from the plurality of products based on the rates of cross-sampled pairs of the plurality of products involving the first product. For example, a P(probability)10 lower confidence bound measure can be calculated for every cross-sampled pair of products for the plurality of products involving the first product, and for example results utilized only for those pairs for which P10 is larger than 5%. A P10 larger than 5% provides at least a 90% confidence that at least 1 in 20 (5%) of the customers will “click-through” the recommended product. The click-through rate is defined herein as the positive action of a customer adding a recommended product to the electronic “cart” for an order divided by the total number of cross sample product offers. Other P measures and %'s may also be used.

The first and second statistical model can be utilized, as they work independently, so that the output (the collective recommended products) can be the merged result of the respective models. In one particular embodiment, some product matches are taken from each of the models.

As noted above, the calculating of rates can include calculating a P-value for rates of the cross-sampled pairs. The recommending of at least a second recommended product can comprise recommending two or more of the plurality of products from the cross-sampled pairs in a descending order of p-value. The products in one particular embodiment comprise semiconductor devices. Among all the historical pairs of cross-sampled products, the pairs can be recommended in descending order of the selected lower confidence bound value. The best cross-sampled pairs can be based on the long term proportion of cross-samples. The cross samples can be recommended to the customer on a sampling Internet web page in the descending order.

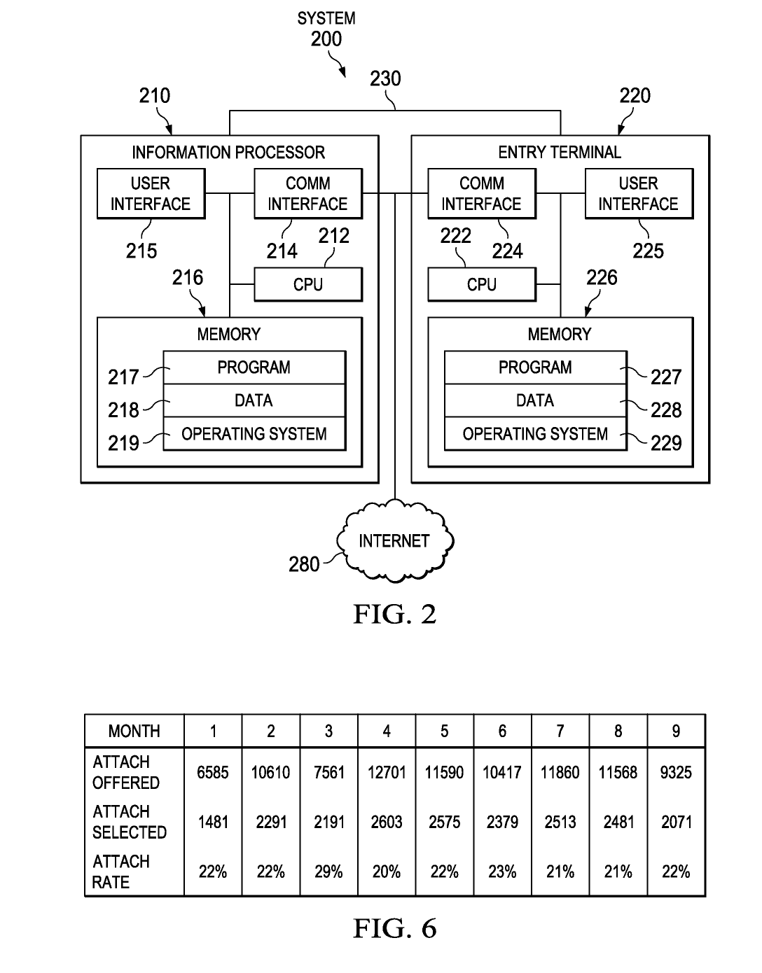

FIG. 2 is an example system 200 for recommending products based on statistics during e-commerce, according to an example embodiment. System 200 includes an Information Processor (IP) 210 and at least one Entry Terminal (ET) 220. ET 220 is communicatively coupled to IP 210 over a communication system 230 that can comprise a variety of connections, such as an intranet connection. Communication system 230 is connected to the Internet 280 to allow communication with on-line customers. ET 220 includes a computing device 222 shown as central processing unit (CPU) including a processor (e.g., a digital signal processor) which executes program instructions which carry out the sequence of steps for disclosed embodiments including a disclosed automatic system for recommending products during e-commerce.

ET 220 includes communication interface 224, which transmits and receives signals over communication system 230 under control of CPU 222. These signals represent messages generated by CPU 222 and messages destined for CPU 222. ET 220 includes a non-transitory memory 226, which stores program instructions and data used by CPU 222. Memory 226 is shown including a program partition 227, which stores the program instructions executed by CPU 222 in performing certain disclosed functions, data partition 228, which stores data used by CPU 222 in conjunction with the program instructions in program partition 227, and operating system 229.

Memory 226 can comprise random access memory (RAM) devices and may include other non-transitory (tangible) machine readable storage devices such as, for example, hard disk storage devices, floppy disk storage devices, tape storage devices, optical disk storage devices and read-only memory (ROM) devices. ET 220 also includes user interface 225, which allows a customer to enter and receive product information. User interface 225 typically includes, for example, a display and a keyboard, and may include a device such as a mouse.

IP 210 includes a computing device 212 shown as CPU 212 that generally includes a processor which executes program instructions which carry out the sequence of steps for disclosed embodiments. IP 210 includes communication interface 214, which transmits and receives signals over communication system 230 under control of CPU 212. These signals represent messages generated by CPU 212 and messages destined for CPU 212. IP 210 includes memory 216, which stores program instructions and data used by CPU 212. Memory 216 is shown including program partition 217, which stores the program instructions executed by CPU 212 in performing disclosed functions, data partition 218, which stores data used by CPU 212 in conjunction with the program instructions in program partition 217, and operating system 219. Memory 216 can comprise RAM devices and may include other storage devices such as, for example, hard disk storage devices, floppy disk storage devices, tape storage devices, optical disk storage devices and ROM devices. IP 210 may also include user interface 215, which allows a system operator to observe and control operations. User interface 215 typically includes, for example, a display and a keyboard, and may include a device such as a mouse.

Advantages of disclosed embodiments include the use of historical cross-sampling data to build statistical models that predict which product pairs are the rising stars, which can be significant particularly in cases of new product introductions. Disclosed embodiments also provide the option to combine rising stars with products identified from cross samples which have performed done best historically.

### EXAMPLES

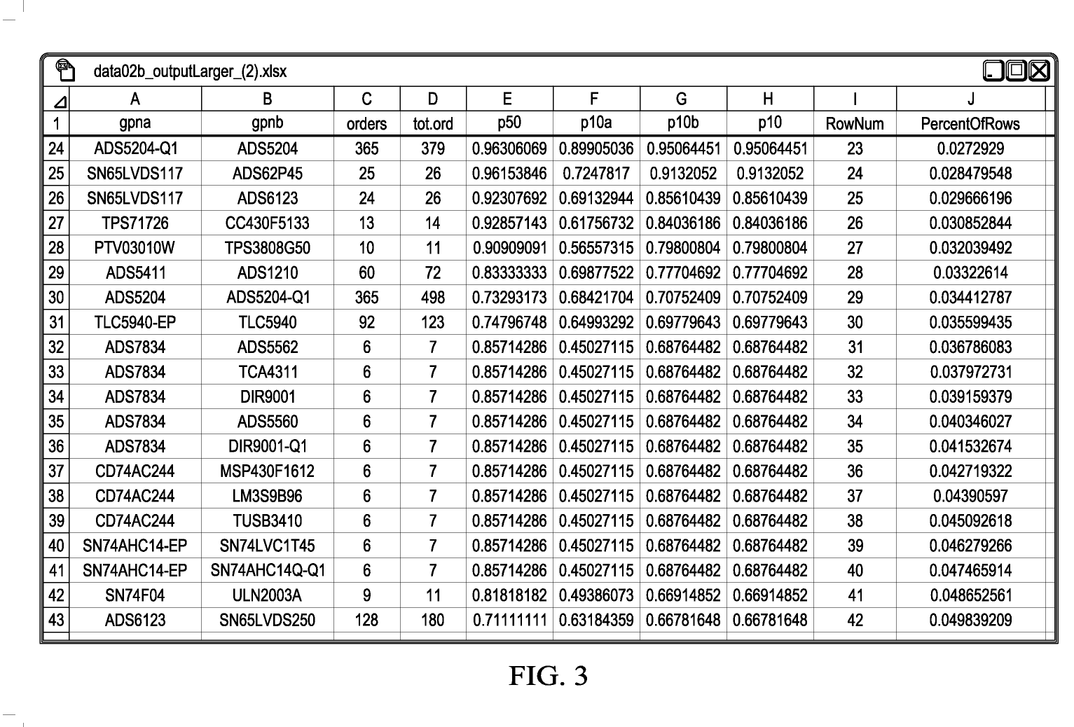

FIG. 3 is a portion of a data table that includes data associated with implementation of the second statistical model which using cross sampling rates is operable as noted above to identify long term winning (high relative probability) cross matches. Each combination of Col. A and Col. B represents a cross match of first and second electronic devices. Col. H shows the P10 value which is a calculated lower confidence bound (e.g., the 10% Lower Confidence Bound (P10)) on the proportion of sample orders of a first product that have a given cross sample of another product. For P10, there is at least 90% confidence as long as P10>0.05 that more than 1 in 20 customers will partake (click-through) when presented the recommended product offered. The larger the P10 the better the match.

Among all these historical pairs of cross-sampled products, the cross-sampled products can be recommended in descending order of this lower confidence bound value as shown in FIG. 3. For example, if the customer selects the ADS7834 (a 12-Bit High Speed Low Power Sampling Analog-to-Digital Converter), the highest P10 value is for ADS5562 (a 16-Bit, 40/80 MSPS Analog-to-Digital Converter) which is shown above other cross matches including ADS7834, so that ADS5562 would be automatically recommended to a customer that had already just selected the ADS7834.

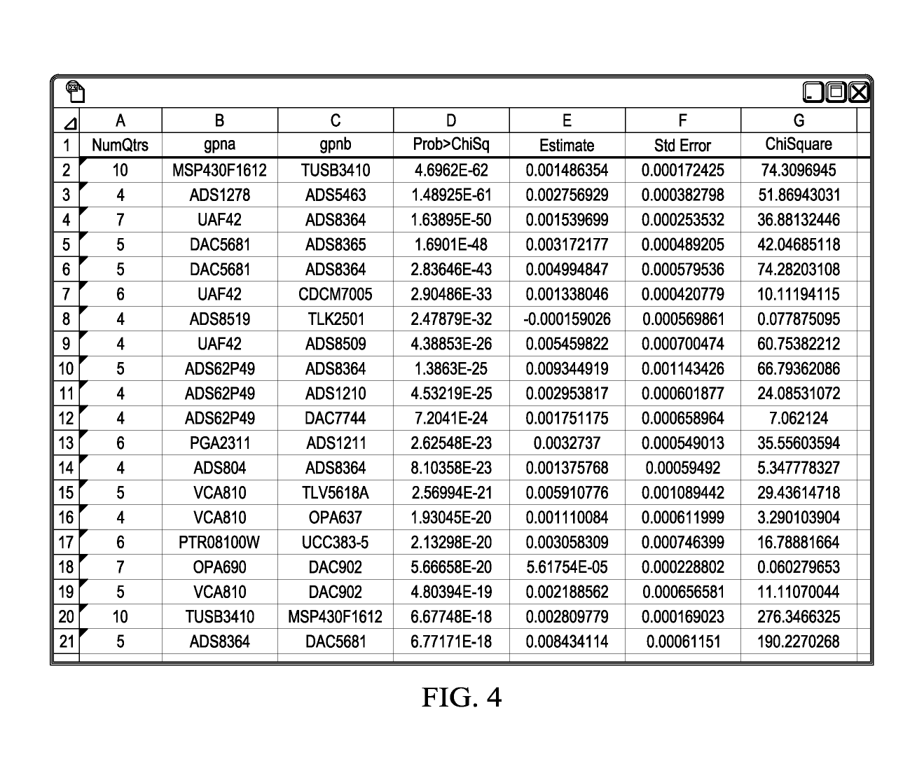

FIG. 4 is a portion of a data table that includes data associated with implementation of the first statistical model which is operable as noted above to identify rising stars. Col. A shows the number of quarters the customer' data is divided into, where the quarter is the time covariate used. Each combination of Col. B and Col. C represents a cross match of first and second electronic devices. The p-value is in col. D and is labeled as Prob>ChiSq. Entries are ranked based on the smallest p-value.

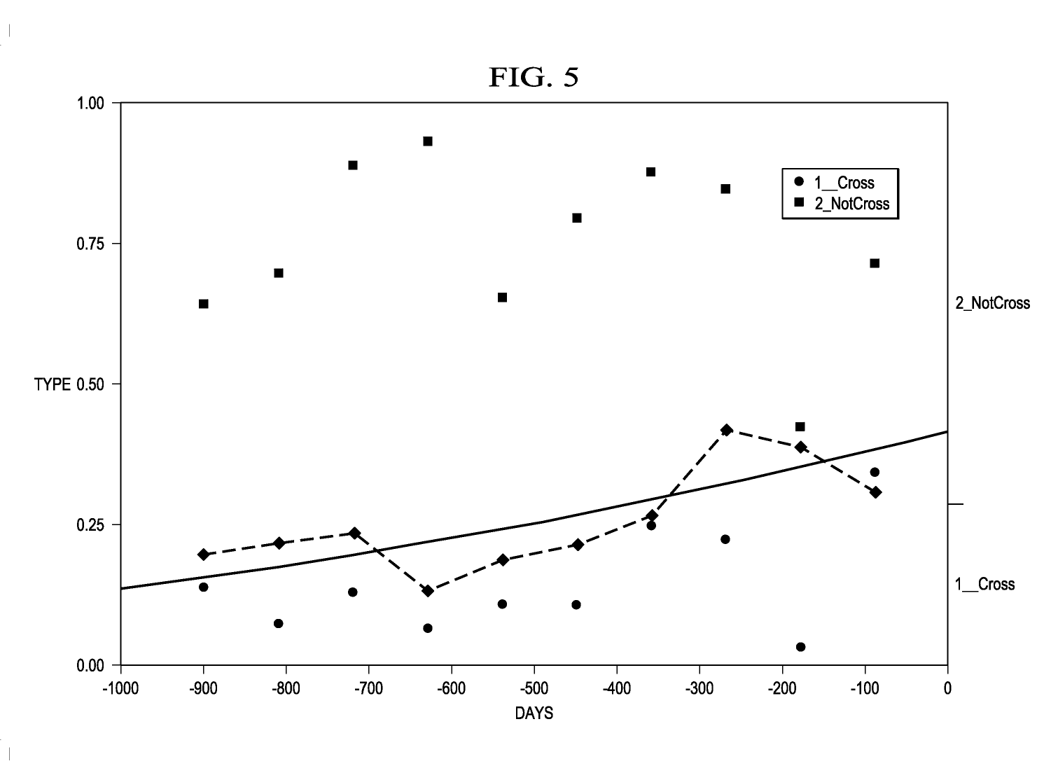

FIG. 5 is a plot (graph) of type as a function of time over a 1,000 day period for a particular cross match (10 quarters), so that 10 time periods having data are shown each representing a particular quarter. In the graph provided, the smooth curve is the model curve and the jagged line is the observed data. There are other points plotted above the model curve which are not connected to one another. These non-connected points on the graph are randomly spaced between the model curve and the top or bottom of the graph borders. The y position of the non-connected points has no meaning. The purpose of the non-connected points is to show that the dataset has data for ‘matches’ and for ‘non matches’ for every one of the 10 quarters shown.

A mathematical explanation of the first statistical mode and the second statistical models is now described.

For the first statistical model:

$$let the probability ( cross order / t ) = f ( t ) = [ exp ( a + bt ] ) / [ 1 + exp ( a + bt ) ]$$

$$then the probability ( not cross order / t ) = 1 - f ( t ) = [ 1 ] / [ 1 + exp ( a + bt ) ] \\ [ f ( t ) ] / [ 1 - f ( t ) ] = exp ( a + bt ) = Odds ( O )$$

$$ln [ f ] / [ 1 - f ] = a + bt = ln ( O ) = logit ( f )$$

$$L = likelihood = {\prod }_{i}^{ } {[ f ( {t}_{i} ) ]}^{Si} \cdot {[ 1 - f ( {t}_{i} ) ]}^{Fi}$$

$$L = {[ 1 / ( 1 + exp ( 900 b - a ) ) ]}^{0} \cdot {[ 1 / ( 1 + exp ( a - 900 b ) ) ]}^{188} \cdot {[ 1 / ( 1 + exp ( 810 b - a ) ) ]}^{10} \cdot {[ 1 / ( 1 + exp ( a - 810 b ) ) ]}^{332} \cdot … \cdot {[ 1 / ( 1 + exp ( 90 b - a ) ) ]}^{147} \cdot {[ 1 / ( 1 + exp ( a - 90 b ) ) ]}^{808}$$

Set partial derivatives for L with respect to a and b, and solve for an estimate for a “est(a)” and an estimate for b “est(b)”. The Newton-Raphson numerical method can be used to solve for (est(a)) and est(b), yielding est(a)=−1.3068 and standard error (SE) est(a)=0.103

est(b)=0.0036 and SE (est(b))=0.00039.

Let Q (est(a))=(1.3068/0.103)=160.35

By theory this has a x² distribution to 1 degree of freedom.

Prob (Q>160.35)<<0.0001, so that Ho1 [intercept=0] is rejected

Let Q(est(b)=(0.0036/0.000398)²=81.58

Prob (Q>81.58)=1.68 exp⁻¹⁹<<0.0001

so that Ho2 [the slope is 0] is rejected

If [Ho2: slope=0] is true, the probability of getting a Q value of 81.58 or more is only about 2 exp⁻¹⁹. It is almost impossible to get Q_{observed}>81.58 whenever Ho2 is true.

For the Second Statistical Model,

a normal approximation to the binomial distribution is used to set P10 based on knowing the count of orders and the count of orders with that particular pair matched in them. Consider row 25 of a long time interval (e.g. 3 years) spreadsheet, where each row includes a specific cross match including a first product and a second product, with the rows including a number of recommendation made and a % of click-throughs over the time interval.

Assume there is matching on 25 of the 26 orders. The estimated match probability p* is thus 25/26=0.961 and the standard deviation (or standard error) (σ) for the p* is calculated as σ=sqrt(0.961538*(1−0.961538)/26)=0.038.
P10 is then calculated from the normal approximation as:
P10=p*−1.28(σ)=0.913; where 1.28 is the quantile from the Standard Normal distribution for 90%, usually called a Z score. By integrating a N(0,1) distribution from minus infinity up to 1.28, the integral is 0.9, or 90% Likewise, the quantile associated with the 10th percentile, P10, from a Standard Normal distribution is −1.28, being the number shown on the equation for P10 above.
P10=0.913>>0.05 provides at least a 90% confidence that at least 1 in 20 customers will click-through upon a cross sample recommendation for this product pair.

FIG. 6 shows actual click-through rate data obtained after implementing a disclosed automatic CSRA that included both of the first and second statistical models. As noted above, the click-through rate is defined as the positive action of a customer adding a recommended product to the electronic “cart” for an order shown as an “attach rate” calculated by dividing the number of “attach selected” by the total number of cross sample product offers shown as “attached offered”. Before the implementation of a disclosed CSRA, the click-through rate was consistently 5% or less using recommending cross sample products based only upon an engineering cross table database that was created using human judgment, using if/then statements and indexing to come up with the recommended products. Evidence in FIG. 6 shows the click-through rate rose to at least 20% over 9 consecutive months, representing a 300+% increase in click-through rate.

Those skilled in the art to which this disclosure relates will appreciate that many other embodiments and variations of embodiments are possible within the scope of the claimed invention, and further additions, deletions, substitutions and modifications may be made to the described embodiments without departing from the scope of this disclosure.

1. A system for recommending products during e-commerce, comprising:
a computing device including a processor connected to a memory which controls operations at an on-line website; wherein said memory stores an automatic cross sampling recommender algorithm (CSRA) and said computing device is programmed to implement said CSRA which includes at least a first statistical model,
responsive to receiving information via a communications path including the Internet from a first customer including said customer selecting a first product from a plurality of products offered at said on-line website, said CSRA automatically:
dividing historical customer' selection information for said plurality of products spanning a first period of time into a plurality of time ordered sub-periods of time;
using said customer' selection information in said time ordered sub-periods of time as a time covariate, fitting logistic regressions to each of a plurality of cross-sampled pairs of said plurality of products involving said first product,
using data obtained from said logistic regressions, identifying which of said plurality of cross-sampled pairs meets a slope selection criteria including both a non-zero slope based on a predetermined statistical significance measure, and said non-zero slope being a positive slope, and
recommending to said first customer at least a first recommended product from said plurality of cross-sampled pairs provided at least one of said plurality of cross-sampled pairs meets said slope selection criteria.

2. The system of claim 1, wherein said predetermined statistical significance measure is a p (probability)-value being below a predetermined level, wherein a null hypothesis corresponds to a zero slope, and wherein said null hypothesis is rejected to determine said non-zero slope is present only when said p-value is below said predetermined level.

3. The system of claim 2, wherein if none of said plurality of cross-sampled pairs meet said slope selection criteria, raising said p-value to a new p-value above said predetermined level and then repeating said fitting logistic regressions, said identifying, and said recommending.

4. The system of claim 1, wherein said CSRA further includes a second statistical model, said CSRA automatically:
calculating rates of said plurality of cross-sampled pairs involving said first product over said first period of time,
wherein said recommending further comprises recommending at least a second recommended product from said plurality of products based on said rates of said plurality of cross-sampled pairs of said plurality of products involving said first product.

5. The system of claim 4, wherein said calculating rates includes calculating a p probability)-value for each of said rates of said plurality of cross-sampled pairs, and wherein said recommending at least a second recommended product comprises recommending two or more of said plurality of products from said plurality of cross-sampled pairs in a descending order of said p-value.

6. The system of claim 4, wherein said recommending recommends at least one product identified by said first statistical model and recommends at least one product identified by said second statistical model.

7. The system of claim 1, wherein said plurality of products consist essentially of semiconductor devices.

8. An on-line method of recommending products during e-commerce, said method comprising:
providing a computing device including a processor connected to a memory which controls operations at an on-line website; wherein said memory stores a cross sampling recommender algorithm (CSRA) and said computing device is programmed to implement said CSRA which includes at least a first statistical model,
responsive to receiving information via a communications path including the Internet from a first customer including said customer selecting a first product from a plurality of products offered at said on-line website, said CSRA automatically:
dividing historical customer' selection information for said plurality of products spanning a first period of time into a plurality of time ordered sub-periods of time;
using said customer' selection information in said time ordered sub-periods of time as a time covariate, fitting logistic regressions to each of a plurality of cross-sampled pairs of said plurality of products involving said first product,
using data obtained from said logistic regressions, identifying which of said plurality of cross-sampled pairs meets a slope selection criteria including both a non-zero slope based on a predetermined statistical significance measure, and said non-zero slope being a positive slope, and
recommending to said first customer at least a first recommended product from said plurality of cross-sampled pairs provided at least one of said plurality of cross-sampled pairs meet said slope selection criteria.

9. The method of claim 8, wherein said predetermined statistical significance measure is a p (probability)-value being below a predetermined level, wherein a null hypothesis corresponds to a zero slope, and wherein said null hypothesis is rejected to determine said non-zero slope is present only when said p-value is below said predetermined level.

10. The method of claim 9, wherein if none of said plurality of cross-sampled pairs meet said slope selection criteria, raising said p-value to a new p-value above said predetermined level and then repeating said identifying and said recommending.

11. The method of claim 8, wherein said CSRA further includes a second statistical model, said CSRA automatically:
calculating rates of said plurality of cross-sampled pairs involving said first product over said first period of time,
wherein said recommending further comprises recommending at least a second recommended product from said plurality of products based on said rates of said plurality of cross-sampled pairs of said plurality of products involving said first product.

12. The method of claim 11, wherein said calculating rates includes calculating a p probability)-value for each of said rates of said plurality of cross-sampled pairs, and wherein said recommending at least a second recommended product comprises recommending two or more of said plurality of products from said plurality of cross-sampled pairs in a descending order of said p-value.

13. The method of claim 11, wherein said recommending recommends at least one product identified by said first statistical model and recommends at least one product identified by said second statistical model.

14. The method of claim 8, wherein said plurality of products consist essentially of semiconductor devices.
